(19) United States
(12) Patent Application Publication
(10) Pub. No.: US 2023/0042645 A1
(43) Pub. Date: Feb. 9, 2023

(54) LEVEL MEASUREMENT APPARATUS AND METHOD

(71) Applicant: JOHNSON MATTHEY PUBLIC LIMITED COMPANY, London (GB)

(72) Inventor: Neil BORRELL, Billingham, Cleveland (GB)

(21) Appl. No.: 17/758,850

(22) PCT Filed: Jan. 4, 2021
(86) PCT No.: PCT/GB2021/050002

§ 371 Date: Jul. 14, 2022

(30) Foreign Application Priority Data
Mar. 6, 2020 (GB) 2003332.0

(51) Int. Cl. G01F 23/284

(52) U.S. Cl. CPC G01F 23/284

(57) ABSTRACT

An apparatus for determining the identity, location or level of one or more material phases or the location of an interface between two material phases, the apparatus comprising: an array of radio frequency (RF) transmitters and receivers for transmitting and receiving RF signals, the array being configured to be at least partially submerged within one or more material phases; and a Faraday cage in which the array of RF transmitters and receivers is disposed, the Faraday cage defining a measurement zone in which RF signals from the RF transmitters are contained and external RF signals are excluded, at least a portion of the one or more material phases being disposed within the measurement zone when the array is submerged within the one or more material phases; wherein the transmitters are arranged to transmit RF signals into the one or more material phases in the measurement zone when the array is submerged within the one or more material phases, and the receivers are arranged to receive RF signals passing through the one or more material phases in the measurement zone when the array is submerged within the one or more material phases; the apparatus being configured to process the received RF signals to determine the identity, location, or level of the one or more material phases or the location of an interface between two material phases.

### FIELD

The present invention relates to an apparatus for determining the identity, location or level of one or more material phases or the location of an interface between two material phases within a vessel such as an oil separator unit.

### BACKGROUND

The measurement of levels of fill, particularly of fluids including liquids, gases and multi-phase materials such as emulsions and slurries, has been carried out for many years using nucleonic level gauges, by measuring the amount of radiation emitted by a radiation-source which is detected at one or more levels within the vessel. The radiation is attenuated as is passes through materials, the amounts of attenuation being related to the density of the materials between a source and a detector. By comparing the attenuation of radiation detected at different levels of the vessel, it is possible to estimate the height of materials contained in the vessel.

A density profiler based on these principles has been described in WO2000/022387. The device comprises a linear array of sources of ionising radiation which emit radiation towards detectors disposed in one or more linear arrays. When the source array and detector array(s) are positioned so that they traverse the interfaces between two or more fluids in a vessel, the interfaces of the fluids may be identified from the differences in radiation received by each detector in the array. These devices have been successfully deployed for use in storage tanks and oil separators.

However, it may be undesirable to use a device which embodies a source of ionising radiation. In some parts of the world nucleonic technology may not be a viable option. Alternative detector arrangements with similar functionality that do not require a source of ionising radiation have accordingly been proposed.

Radar level gauge systems are known for measuring fluid levels in vessels. In particular, guided wave radar level sensor probes are known in which transmitted electromagnetic signals are guided towards and into the vessel by a wave guide, typically arranged vertically from top to bottom of the vessel. The electromagnetic signals are reflected at a fluid surface and received back at the level gauge system by a receiver. The time from emission to reception of the signals is used to determine the level in the vessel.

However, traditional guided wave radar solutions have limitations. For example, while guided wave solutions can detect a clean oil-water interface, they cannot detect an oil-water interface if there is an emulsion in the way. Furthermore, microwaves don't transmit through water and so don't probe effectively beyond a water interface.

It is an aim of the invention to provide a non-nucleonic measurement instrument for measuring levels of materials, especially of fluids, and optionally for measuring/calculating a level profile of a multi-layer fluid column, that mitigates some or all of the foregoing disadvantages of current nucleonic and guided wave radar solutions and/or offers an alternative functionality and/or enhanced accuracy.

### SUMMARY OF THE INVENTION

The present specification provides an apparatus for determining the identity, location or level of one or more material phases or the location of an interface between two material phases, the apparatus comprising:
an array of radio frequency (RF) transmitters and receivers for transmitting and receiving RF signals, the array being configured to be at least partially submerged within one or more material phases; and
a Faraday cage in which the array of RF transmitters and receivers is disposed, the Faraday cage defining a measurement zone in which RF signals from the RF transmitters are contained and external RF signals are excluded, at least a portion of the one or more material phases being disposed within the measurement zone when the array is submerged within the one or more material phases;
wherein the transmitters are arranged to transmit RF signals into the one or more material phases in the measurement zone when the array is submerged within the one or more material phases, and the receivers are arranged to receive RF signals passing through the one or more material phases in the measurement zone when the array is submerged within the one or more material phases;
the apparatus being configured to process the received RF signals to determine the identity, location, or level of the one or more material phases or the location of an interface between two material phases.

The present specification also provides a method for determining the identity, location or level of one or more material phases or the location of an interface between two material phases, the method comprising:
introducing the apparatus into the one or more material phases such that the one or more material phases at least partially fill the measurement zone;
transmitting RF signals into the measurement zone;
receiving RF signals through the one or more material phases in the measurement zone; and
processing the RF signals to determine the identity, location, or level of one or more material phases or the location of an interface between two material phases.

The signal strength of the received RF signals is dependent on the nature of the materials through which the RF signals have been transmitted. As such, variations in signal strength at different locations along the array gives information about variations in the materials along the array. As such, it is possible to identify the location of different layers of material within a multi-layered fluid column and the location of interfaces between different material phases. Furthermore, using suitable pre-calibration, it is possible to determine the identity of the material phases.

While in principle separate RF transmitter and RF receiver units can be provided, in certain configurations the array of RF transmitters and receivers is provided as an array of RF transceivers. This configuration can provide a more simplified and compact apparatus configuration. When RF transceiver units are provided, the apparatus can be configured to switch the RF transceivers between transmit and receive modes in a sequence such that at least one of the RF transceivers is in transmit mode and at least one of the RF transceivers is in receive mode at any one time. The array of RF transceivers can be provided by an array of WiFi modules, Bluetooth modules, Zigbee modules, or any other modules which provide a radio frequency and type of modulation that interacts with the target material phases (e.g. fluids) under investigation. Such RF modules are cheap, readily available, robust, reliable, easy to program, and require only simple control electronics. As such, the present invention provides a new application for this well-established technology from the wireless telecommunications field. Testing has found that Bluetooth modules provide a particularly good performance in this application space compared to other types of RF modules.

Since widely used RF telecommunications technology is implemented in the apparatus, the apparatus comprises a Faraday cage to define a measurement zone in which RF signals from the RF transmitters are contained and external RF signals are excluded. The material phases under investigation enter the measurement zone when the apparatus is submerged within the material phases. The Faraday cage may be of any design which confines the RF signals from the transmitters and excludes external RF signals which would otherwise interfere with the apparatus. In addition to excluding external interreference from other RF devices in the vicinity, the Faraday cage also alleviates any possibility of malicious introduction of RF signals.

The level measurement apparatus as described herein is capable of profiling complex multi-layered fluid columns including oil/water interfaces and emulsions which may be found in an oil separator unit. As such, the apparatus can provide a functional improvement over prior art radar level gauge systems, while also avoiding the use of nucleonic sources. One reason for the improved functionality is that the electromagnetic radiation is not directed through the fluid layers from above. Rather, the electromagnetic radiation is provided by an array of RF modules at defined vertical locations through a fluid column. In this respect, the configuration is analogous to the provision of multiple nucleonic sources at defined vertical locations. Multiple RF modules can be disposed at varying depths of the fluid column and function to provide multiple interrogation points. Furthermore, another advantage of the present RF-based level measurement apparatus over prior art nucleonic level measurement devices is that data from any single RF receiver can contain both the location and signal strength for every RF transmitter in the array, whereas in prior art nucleonic systems each detector only reports the received signal strength of a collimated source adjacent to that detector. As the present apparatus can generate more dimensions of data than the prior art nucleonic devices, it is possible to extract more information about the process being monitored. That is, a matrix of signal strengths for a plurality, optionally all, of receive-transmit combinations in the array can be generated. For example, using a 30-transceiver array it is possible to generate a matrix of 900 signal strength measurements that can be attributed to different receive-transmit combinations. This type of data lends itself to machine/deep learning processes. Testing indicates that more accurate compositional and positional information can be achieved using this approach over standard methods of measuring signals between pairs of transmitters and receivers. As such, the apparatus of the present specification can be configured such that each RF receiver is configured to measure signal strengths from a plurality of the RF transmitters in the array thereby generating a matrix of signal strengths for a plurality of receiver-transmitter combinations, the apparatus being configured to process the matrix of signal strengths to determine the identity, location, or level of the one or more material phases or the location of an interface between two material phases.

### BRIEF DESCRIPTION OF THE DRAWINGS

The invention will now be described by way of example only with reference to the accompanying drawings, in which:

FIG. 1 shows a schematic of a level measurement apparatus for insertion into a vessel comprising a multi-layered fluid column to measure the profile of the fluid column;

FIG. 2 shows a schematic of a control electronics configuration for the level measurement apparatus;

FIGS. 3 to 5 show examples of signal patterns for a level measurement apparatus with an array of 20 WiFi modules; and

FIG. 6 is a schematic depiction of an oil-water separator including a level measurement apparatus.

### DETAILED DESCRIPTION

As described in the summary section, the present specification provides an apparatus for determining the identity, location or level of one or more material phases or the location of an interface between two material phases. The apparatus comprises an array of radio frequency (RF) transmitters and receivers for transmitting and receiving RF signals. The apparatus may further comprise an enclosure in which the array of RF transmitters and receivers is disposed. The array is configured to be at least partially submerged within one or more material phases, e.g. in a vessel such as an oil separator unit. A Faraday cage is also provided around the array of RF transmitters and receivers. The Faraday cage define a measurement zone around the RF array in which RF signals from the RF transmitters are contained and external RF signals are excluded. At least a portion of the one or more material phases are disposed within the measurement zone when the array is submerged within the one or more material phases. The transmitters are arranged to transmit RF signals into the one or more material phases in the measurement zone when the array is submerged within the one or more material phases, and the receivers are arranged to receive RF signals passing through the one or more material phases in the measurement zone when the array is submerged within the one or more material phases. The apparatus is configured to process the received RF signals to determine the identity, location, or level of the one or more material phases or the location of an interface between two material phases.

Various configurations are possible for the apparatus. For example, the apparatus may comprise an elongate dip pipe with the array of RF transmitters and receivers disposed along the elongate dip pipe either along the outside or the inside of the dip pipe. The Faraday cage can be physically attached to the array and/or dip pipe. In one configuration, the dip pipe can be configured to function as a Faraday cage if the array of RF transmitters and receivers is disposed within the dip pipe. Alternatively, the Faraday cage can be a physically separate component to the array and/or dip pipe. For example, the Faraday cage can be formed by, or be integral with, a vessel in which the material phases under investigation are disposed in use. In this case, the vessel can form a structural and/or functional part of the apparatus.

To make it easier to determine the source of each RF signal, each RF transmitter can be configured to transmit a unique identifier code. As such, the source and location of each transmitted RF signal can be determined. This is particularly useful when operating in a mode in which more than one RF transmitter is transmitting at the same time.

While in principle separate RF transmitter and RF receiver units can be provided, in certain configurations the array of RF transmitters and receivers is provided as an array of RF transceivers. This configuration can provide a more simplified and compact apparatus configuration. When RF transceiver units are provided, the apparatus can be configured to switch the RF transceivers between transmit and receive modes in a sequence such that at least one of the RF transceivers is in transmit mode and at least one of the RF transceivers is in receive mode at any one time. According to one mode of operation, the switching sequence comprises: switching one of the RF transceivers to receive mode; instructing one or more of the other RF transceivers to transmit; switching another of the RF transceivers to receive mode; instructing one or more of the other RF transceivers to transmit; and repeating the sequence until a desired number, or all, of the RF transceivers have been in receive mode. The result is that every RF transceiver module, or at least a desired set of RF transceiver modules, can receive a signal from every other RF transceiver module, or a desired set of RF transceiver modules. A matrix of signal strengths is obtained that gives more information about the material phases than a single point measurement. The scanning sequence may also be arranged in combinations or permutations of receiving and transmitting sequences to speed up measurement time.

The array of RF transmitters and receivers can be provided by an array of WiFi modules, Bluetooth modules, Zigbee modules, or any other modules which provide a radio frequency and type of modulation that interacts with the target material phases (e.g. fluids) under investigation. For example, a 5 GHZ WiFi band can be selected which interacts strongly with fluid phases leading to more sensitive measurements but over a limited volume of material around the array.

In certain embodiments of the present invention the array of RF transmitters and receivers is provided by an array of WiFi modules. WiFi modules are cheap, readily available, robust, reliable, easy to program, and require only simple control electronics. Each WiFi module can be readily instructed to transmit a unique Service Set Identifier (SSID). Furthermore, each WiFi module can be readily instructed to identify received signals and measure signal strength for each of the received signals. As such, the present invention provides a new application for this well-established technology from the wireless telecommunications field.

In order to increase the security of the apparatus, an encrypted password can be used for connection to the WiFi array to perform signal strength measurements. An alternative or additional feature involves a receiving module being programmed with a unique code before being set to transmit. The next receiving module can detect this code and pass on a code when it is set to transmit. In this way, codes can be rolled over the array to control transmission and reception. Another security feature is to send an encrypted message from a client device which is decrypted by a station, and if valid an encrypted response is sent back to enable operation of the apparatus.

The array of RF transceivers can be mounted in an RF transparent medium which physically isolates the array from the one or more material phases in the measurement zone when the array is submerged within the one or more material phases.

The apparatus can also be configured to include an electronic controller disposed in a controller housing which can be physically separate from the array/dip pipe. This ensures that the electronics can be safely isolated from the conditions within the vessel in which the RF array is located. An array of antennas can be provided and electrically connected to the controller in the controller housing by one or more cables. Alternatively, a wireless connection can be provided for controlling the apparatus from a control device which may, for example, be a laptop, smart phone, or tablet computing device.

The array of RF transmitters and receivers can be in the form of a linear array, a 2D grid array, or a 3D grid array. For example, RF transceivers may be arranged in a vertical linear array for use in a profiler or in a grid pattern in which case 3D resolution is possible.

The type of RF transmitter/antenna can be selected to give a specific radiation pattern and therefore some control of the measurement zone. Furthermore, detection characteristics may be modified by selecting a type of antenna to give a specific radiation pattern and interaction with the one or more material phases under investigation. Examples include dipole, helical, and ceramic patch antennas. For example, the RF transmitters/antennas can be configured to transmit a toroidal radiation pattern, e.g. from a helical design antenna.

The above described apparatus can be used to determining the identity, location or level of one or more material phases or the location of an interface between two material phases within a vessel. An example is now described which provides a level measurement apparatus comprising an array of WiFi transceiver modules.

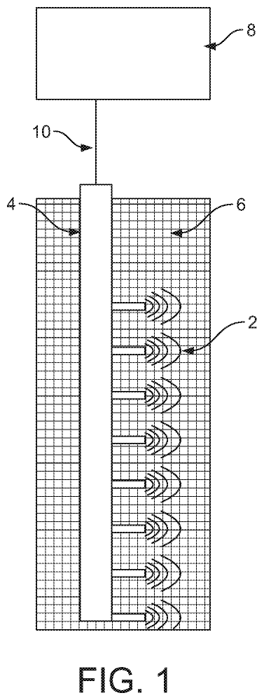

FIG. 1 shows a schematic of such a level measurement apparatus for insertion into a vessel comprising a multi-layered fluid column to measure the profile of the fluid column. The apparatus comprises an array of WiFi modules 2 located along the length of a profiler dip tube 4 within a Faraday cage 6 so that RF signals are contained within a measurement zone and external signals are excluded. The apparatus may comprise at least 10 or 20 modules for example. The WiFi modules may be arranged in a linear array as in the illustrated configuration or they may be arranged in a two-dimensional grid to give a 3D image. The apparatus also comprises an electronic controller 8 which is connected to the array of WiFi modules 2 via a bunch of antenna cables 10.

The apparatus can be configured such that fluid enters the measurement zone within the Faraday cage of the apparatus when the dip pipe is immersed in the fluid. To avoid damage or contamination, the WiFi modules can be housed in a medium which physically separates the modules from the fluid while being transparent to the RF signals from the modules. For example, the modules can be mounted in a RF transparent medium such as PTFE (polytetrafluoroethylene), PEEK (polyether ether ketone) or a suitable ceramic. A screen/cage comprising a mesh with, for example, holes of less than half a wavelength of the RF signals (e.g. 4 cm holes) can be placed around the modules to define a measurement zone between the modules and the mesh into which fluid flows when the apparatus is submerged in a fluid column. The cage prevents extraneous signals entering the system and also confines the signals from the modules to the measurement zone.

WiFi modules are cheap, readily available, robust, reliable, easy to program, and require only simple control electronics. Each WiFi module can be readily instructed to transmit a unique Service Set Identifier (SSID). Furthermore, each WiFi module can be readily instructed to identify received signals and measure signal strength for each of the received signals. As such, the present invention provides a new application for this well-established technology from the telecommunications field.

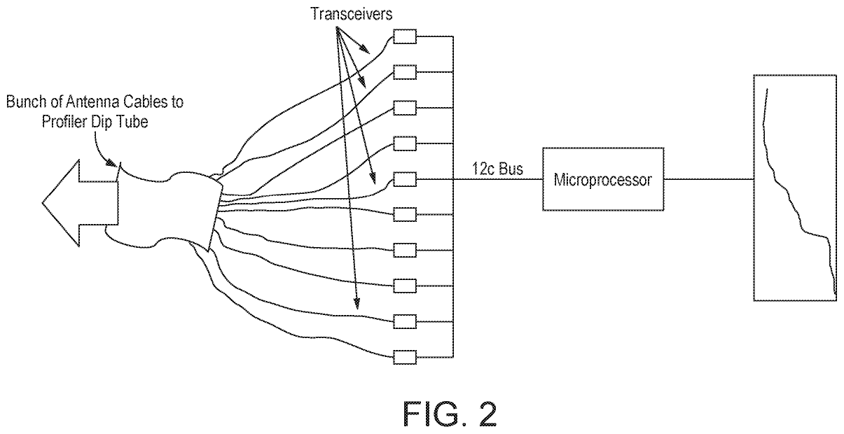

Furthermore, the apparatus can be configured such that there are no complex control electronics in the profiler dip tube. Such a configuration is illustrated in FIG. 2. The configuration avoids temperature or condensation problems affecting the electronics. A microprocessor is coupled to a plurality of transceivers (e.g. ESP07 transceivers) outside of the profiler dip tube. The transceivers are coupled to an array of antennas in the dip tube via a bunch of co-axial antenna cables. The antennas can be those which provide a toroidal radiation pattern, e.g. from a helical design antenna.

WiFi transceiver modules, for example the ESP8266 module, are readily available and have been found to be suitable for this application. Such WiFi modules can easily be programmed to perform the functionality required for this application. For example, the code “long rssi=WiFi.RSSI( )” instructs a module to report the channel number, mac address, identification and signal strength of all WiFi signals in range, while the code “wifi_set_opmode(STATION_MODE)” instructs a WiFi module to transmit. By using a microcontroller to switch an array of these devices alternately between receive and transmit a matrix of received signal strengths for every other node is possible.

In operation a WiFi module is switched to receive and the other modules are sequentially instructed to transmit their unique Service Set Identifier (SSID). In this way, the module set to receive mode will receive signals from transmitting modules around it with a signal strength dependent of the distance from the receiving module and the material between a transmitting module and the receiving module.

Another module is then placed in receive mode and the other modules are sequentially instructed to transmit their SSID. This process is repeated until all modules have been in receive mode. The result is that every transceiver module receives a signal from every other transceiver module. A matrix of signal strengths is obtained that gives more information about the surround material phases in the measurement zone than a single point measurement. As every node can receive a signal from every other node, and conversely every node can transmit a signal to every other node, a complex map of the matrix surrounding the nodes can be built up. Furthermore, the performance of each node can be monitored by multiple other nodes.

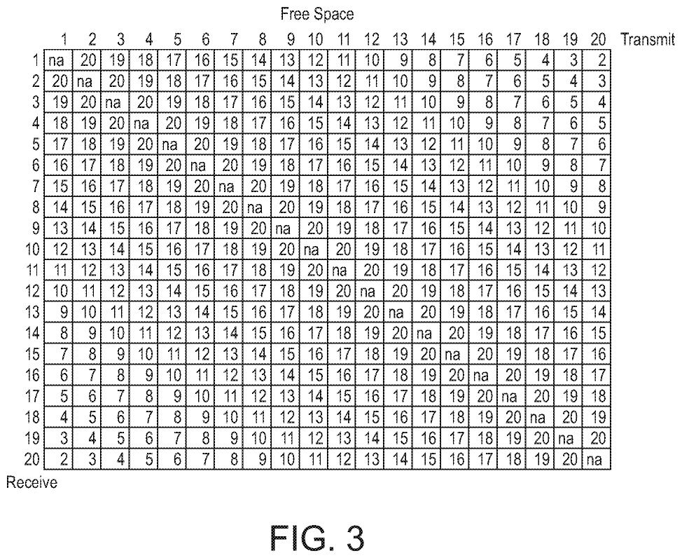

FIGS. 3 to 5 show examples of profiler signal patterns for a profiler with an array of 20 WiFi modules, numbered 1 to 20, along a vertical array with 1 being the uppermost WiFi module and 20 being the lower most WiFi module. Each module in turn is set to a receive mode with the other modules set to transmit so as to build a signal matrix with numerical values equating to signal strength—20 being a strong signal from an adjacent WiFi module reducing towards 0 for weaker signals from more remote modules and/or modules covered in denser materials.

FIG. 3 shows the signal strength matrix for an apparatus in free space. As expected, the matrix is symmetrical across the diagonal and shows that signal strength drops as the distance increases between transmitting and receiving WiFi modules in the array of modules 1 to 20.

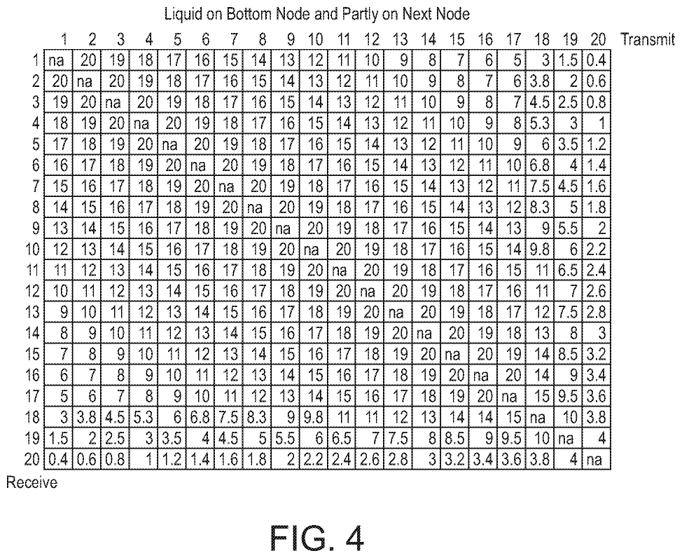

FIG. 4 shows the signal strength matrix for an apparatus with liquid covering the bottom WiFi node (node 20) and partially covering the next WiFi node. The signal strength from the bottom two modules is reduced due to the liquid covering before recovering back to the standard free-space value by node 17.

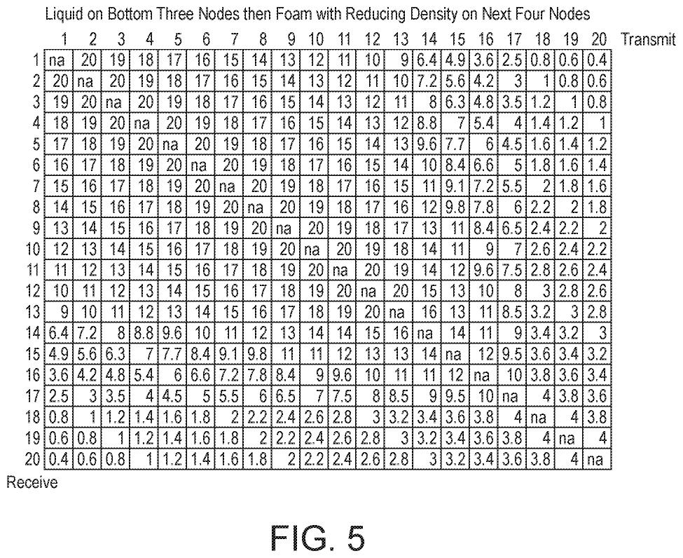

FIG. 5 shows the signal strength matrix for an apparatus with liquid covering the bottom three nodes (18 to 20) and foam having reducing density covering the next four nodes (14 to 17). The signal strength from the bottom three nodes is much reduced due to the liquid covering, while the signal strength gradually increases over the next four nodes in the foam layer before returning to the standard free-space value by node 13.

FIGS. 3 to 5 thus illustrated how the apparatus can be used to deduce information about the position of liquid, foam, and gaseous phases in a fluid column and interfaces therebetween, as well as giving information about variations in density within individual layers such as a foam layer having a varying density.

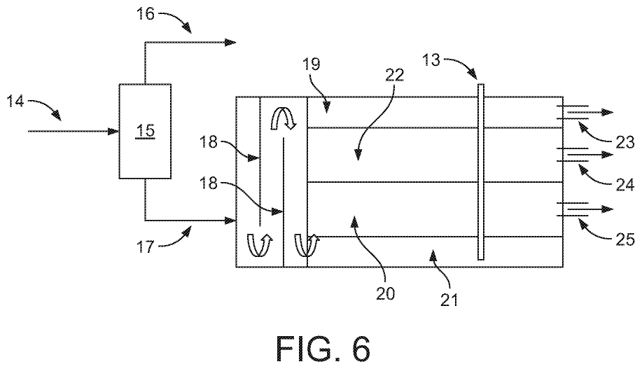

FIG. 6 is a schematic depiction of the level measurement apparatus located within an oil-water separator. The enclosure 13 is shown as arranged in a vertical array that extends substantially the whole height of the separator. The enclosure 13 passes through a wall of the separator vessel and is immersed in the material layers within the vessel. The input flow 14 is a mixture of oil, gas, and water which is passed into a pre-treater 15 to effect preliminary separation of gas which is taken off via line 16, usually for further processing. Liquids, namely oil and water are taken off via line 17. The fluid flow is slowed and rendered less turbulent by baffles 18 before separating into layers of gas 19, water 20, oil 22, and sand or sediment 21. The separate layers flow out of the vessel through respective ports 23, 24, 25. A further port may be provided to remove sand or sediment 21. In operation, the signals detected by the WiFi transceivers within the enclosure 13 are processed to determine the nature of the material at each WiFi transceiver location and thus the location and depth of each of the layers can be determined throughout the separator. It is also possible to determine the presence, location and thickness of any undesirable mixed layers between the gas and water, and between the water and oil layers.

While this invention has been particularly shown and described with reference to certain embodiments, it will be understood to those skilled in the art that various changes in form and detail may be made without departing from the scope of the invention as defined by the appended claims.

1. An apparatus for determining the identity, location or level of one or more material phases or the location of an interface between two material phases, the apparatus comprising:
an array of radio frequency (RF) transmitters and receivers for transmitting and receiving RF signals, the array being configured to be at least partially submerged within one or more material phases; and
a Faraday cage in which the array of RF transmitters and receivers is disposed, the Faraday cage defining a measurement zone in which RF signals from the RF transmitters are contained and external RF signals are excluded, at least a portion of the one or more material phases being disposed within the measurement zone when the array is submerged within the one or more material phases;
wherein the transmitters are arranged to transmit RF signals into the one or more material phases in the measurement zone when the array is submerged within the one or more material phases, and the receivers are arranged to receive RF signals passing through the one or more material phases in the measurement zone when the array is submerged within the one or more material phases;
the apparatus being configured to process the received RF signals to determine the identity, location, or level of the one or more material phases or the location of an interface between two material phases.

2. An apparatus according to claim 1,
wherein each RF transmitter is configured to transmit a unique identifier code.

3. An apparatus according to claim 1,
wherein the array of RF transmitters and receivers is provided by an array of RF transceivers.

4. An apparatus according to claim 3,
wherein the apparatus is configured to switch the RF transceivers between transmit and receive modes in a sequence such that at least one of the RF transceivers is in transmit mode and at least one of the RF transceivers is in receive mode at any one time.

5. An apparatus according to claim 4,
wherein the sequence comprises:
switching one of the RF transceivers to receive mode;
instructing one or more of the other RF transceivers to transmit;
switching another of the RF transceivers to receive mode;
instructing one or more of the other RF transceivers to transmit; and
repeating the sequence until a desired number, or all, the RF transceivers have been in receive mode.

6. An apparatus according to claim 1,
wherein the array of RF transmitters and receivers is provided by an array of WiFi modules, Bluetooth modules, or Zigbee modules.

7. An apparatus according to claim 1,
wherein the array is a linear array, a 2D grid array, or a 3D grid array.

8. An apparatus according to claim 1,
wherein the array is mounted in an RF transparent medium which physically isolates the array from the one or more material phases in the measurement zone when the array is submerged within the one or more material phases.

9. An apparatus according to claim 1,
wherein the apparatus further comprises an elongate dip pipe with the array of RF transmitters and receivers disposed along the elongate dip pipe.

10. An apparatus according to claim 1,
wherein the Faraday cage is physically attached to the array.

11. An apparatus according to claim 1,
wherein the Faraday cage is a physically separate component to the array.

12. An apparatus according to claim 11,
wherein the Faraday cage is formed by, or is integral with, a vessel in which the one or more material phases are disposed in use.

13. An apparatus according to claim 1,
wherein the apparatus comprises an electronic controller disposed in a controller housing and the array comprises an array of antennas which is electrically connected to the controller by one or more cables.

14. An apparatus according to claim 1,
wherein each RF receiver is configured to measure signal strengths from a plurality of the RF transmitters in the array thereby generating a matrix of signal strengths for a plurality of receiver-transmitter combinations, the apparatus being configured to process the matrix of signal strengths to determine the identity, location, or level of the one or more material phases or the location of an interface between two material phases.

15. Use of an apparatus according to claim 1 to determining the identity, location or level of one or more material phases or the location of an interface between two material phases.

16. A method of determining the identity, location or level of one or more material phases or the location of an interface between two material phases, the method comprising:
introducing the apparatus according to claim 1 into the one or more material phases such that the one or more material phases at least partially fill the measurement zone;
transmitting RF signals into the measurement zone;
receiving RF signals through the one or more material phases in the measurement zone; and
processing the RF signals to determine the identity, location, or level of one or more material phases or the location of an interface between two material phases.
